(19) United States
(12) Patent Application Publication
(10) Pub. No.: US 2025/0055146 A1
(43) Pub. Date: Feb. 13, 2025

(54) BUSBAR AND BATTERY ASSEMBLY INCLUDING THE SAME

(71) Applicant: SK On Co., Ltd., Seoul (KR)

(72) Inventors: Yang Kyu CHOI, Daejeon (KR); Woo Young JO, Daejeon (KR)

(21) Appl. No.: 18/783,412

(22) Filed: Jul. 25, 2024

(30) Foreign Application Priority Data
Aug. 8, 2023 (KR) 10-2023-0103481

(51) Int. Cl. H01M 50/503; H01M 50/505; H01M 50/516

(52) U.S. Cl. CPC H01M 50/503; H01M 50/505; H01M 50/516

(57) ABSTRACT

The present disclosure relates to a busbar including a plate; and a plurality of slots formed at the plate, each extending along a first direction, and spaced apart from each other along a second direction which is different from the first direction, wherein the plate includes a body in which the plurality of slots are formed; and a first protrusion formed by extending at least a part of the body along the first direction, and a battery assembly including the same.

### CROSS-REFERENCE TO RELATED PATENT APPLICATION

The present application claims priority under 35 U.S.C. § 119(a) to Korean patent application number 10-2023-0103481 filed on Aug. 8, 2023, in the Korean Intellectual Property Office, the entire disclosure of which is incorporated by reference herein.

### BACKGROUND OF THE INVENTION

### 1. Field

Embodiments of the present disclosure relate to a busbar and a battery assembly including the same.

### 2. Description of the Related Art

A plurality of battery cells may be electrically connected to each other in series or parallel via a busbar. An electrode lead of each of the plurality of battery cells may be inserted into the busbar through a slot or hole. Subsequently, the electrode lead may be welded or attached to the busbar when energy such as laser is applied to the electrode lead.

The way in which current is applied to the busbar through the battery cell may vary according to the shape in which the electrode lead is attached to the busbar. Further, the shape in which the electrode lead is attached may be changed in the process of attaching the electrode lead to the busbar. For example, when the electrode lead is attached only to a part of an outer surface of the slot, the current does not flow uniformly to the busbar, and a problem of overheating only a part of the busbar may occur.

### SUMMARY OF THE INVENTION

According to one aspect of the present disclosure, an object to be achieved is to provide a busbar with improved thermal stability of a battery assembly.

According to another aspect of the present disclosure, an object to be achieved is to provide a battery assembly with improved thermal stability.

The busbar and the battery assembly including the same according to the present disclosure may be widely applied in the field of green technology such as electric vehicles, battery charging stations, energy storage systems (ESS), and other battery-using photovoltaics and wind power. In addition, the busbar and the battery assembly including the same according to the present disclosure may be used for eco-friendly mobility, including electric vehicles and hybrid vehicles, to prevent climate change by suppressing air pollution and greenhouse gas emissions.

A busbar according to an embodiment of the present disclosure includes: a plate; and a plurality of slots formed at the plate, each extending along a first direction, and spaced apart from each other along a second direction which is different from the first direction, wherein the plate includes a body in which the plurality of slots are formed; and a first protrusion formed by extending at least a part of the body along the first direction, and wherein a length of the first protrusion in the first direction may decrease as a distance from a center of the plate increases along the second direction.

In one embodiment, the length of the first protrusion in the first direction may decrease while forming at least one step portion as the distance from the center of the plate increases along the second direction.

In one embodiment, the length of the first protrusion in the first direction may decrease while forming one step portion as the distance from the center of the plate increases along the second direction.

In one embodiment, the length of the first protrusion in the first direction may decrease while forming a plurality of step portions as the distance from the center of the plate increases along the second direction.

In one embodiment, the length of the first protrusion in the first direction may decrease while forming at least one step chamfer portion as the distance from the center of the plate increases along the second direction.

In one embodiment, the length of the first protrusion in the first direction may decrease while forming an inclined portion as the distance from the center of the plate increases along the second direction.

In one embodiment, the length of the first protrusion in the first direction may decrease while forming a curved inclined portion as the distance from the center of the plate increases along the second direction.

In one embodiment, the plate may further include a second protrusion formed by extending at least a part of the body along a direction opposite to the direction in which the first protrusion is extended, and a length of the second protrusion in the direction opposite to the first direction may decrease as the distance from the center of the plate increases along the second direction.

In one embodiment, portions of the plate adjacent to the plurality of slots may be formed to be inclined toward the plurality of slots.

In one embodiment, the busbar may further include ridges disposed along circumference of the plurality of slots.

A battery assembly according to an embodiment of the present disclosure includes: an accommodating case which forms an accommodating space; a first battery cell group disposed in the accommodating space and including a plurality of first battery cells, wherein a first electrode lead of each of the plurality of first battery cells is disposed to face one side; a second battery cell group disposed in the accommodating space and including a plurality of second battery cells, wherein a second electrode lead of each of the plurality of second battery cells is disposed to face the one side; and a busbar electrically connecting the first battery cell group and the second battery cell group, wherein the busbar includes a plate disposed on the one side of the first battery cell group and the second battery cell group; and a plurality of slots formed at the plate, each extending along a first direction, wherein the plurality of slots are spaced apart from each other in a second direction different from the first direction, the plate includes a body in which the plurality of slots are formed; and a first protrusion formed by extending at least a part of the body along the first direction, and a length of the first protrusion in the first direction may decrease as a distance from a center of the plate increases along the second direction.

In one embodiment, the first electrode lead of the first battery cell group and the second electrode lead of the second battery cell group may be attached to the plate while inserted in the plurality of slots.

In one embodiment, at least one of the first electrode lead of the first battery cell group and the second electrode lead of the second battery cell group may be attached to an outer peripheral surface of the slot while inserted in the plurality of slots.

In one embodiment, at least one of the first electrode lead of the first battery cell group and the second electrode lead of the second battery cell group may be attached to only one side of an outer peripheral surface of the slot while inserted in the plurality of slots.

In one embodiment, the first battery cell group may be placed adjacent to the second battery cell group.

In one embodiment, the busbar may electrically connect the plurality of first battery cells of the first battery cell group to each other in parallel, electrically connect the plurality of second battery cells of the second battery cell group to each other in parallel, and electrically connect the first battery cell group and the second battery cell group to each other in series.

In one embodiment, a length of each of the plurality of slots in the first direction may correspond to a length of each of the first electrode lead and the second electrode lead in the first direction, and a length of each of the plurality of slots in the second direction may correspond to a length of each of the first electrode lead and the second electrode lead in the second direction.

According to one embodiment of the present disclosure, it is possible to improve the thermal stability of a busbar.

According to another embodiment of the present disclosure, it is possible to improve the thermal stability of a battery assembly.

### BRIEF DESCRIPTION OF THE DRAWINGS

FIGS. 1 to 3 are front views of a busbar of one embodiment.

FIG. 4 is a plan view of a busbar of one embodiment.

FIG. 5 is an exploded perspective view of a battery assembly of one embodiment.

FIGS. 6 to 8 are cross-sectional diagrams taken along line I-II of FIG. 5.

### DETAILED DESCRIPTION

Hereinafter, the present disclosure will be described in detail with reference to the accompanying drawings. However, this is merely illustrative and the present disclosure is not limited to specific embodiments illustratively described.

In the present disclosure, the term “battery cell” may refer to a basic unit of a lithium secondary battery capable of charging and discharging electrical energy. A battery cell may include a cathode, an anode, a separator, and an electrolyte as a main configuration. The battery cell 10 may include this main configuration and a case accommodating it. The battery cell 10 may further include electrode leads 12 and 13. The electrode leads 12 and 13 may be connected to the cathode and the anode, respectively. The electrode leads 12 and 13 may protrude to the outside of the case such that the battery cell 10 may be electrically connected to the outside.

In the present disclosure, the term “battery module” may refer to an assembly of one or more battery cells 10 contained in a case. The battery module may include one or more battery cells 10 and a busbar electrically connected to the battery cell 10.

In the present disclosure, the term “battery pack” may refer to an assembly including a predetermined number of the battery modules. The battery pack may further include elements such as a cooling system and a battery management system to provide a target voltage or power stably and efficiently.

In the present disclosure, the term “battery cell assembly” or “cell assembly” may refer to a set of battery cells 10 in the battery module or battery pack, excluding the case.

In the present disclosure, the term “battery assembly” may refer to an assembly including a case and a plurality of battery cells 10 accommodated in the case. Therefore, a battery assembly 100 may be distinguished from the battery cell assembly or cell assembly in that it further includes the case.

In the present disclosure, the battery assembly 100 may be used to include both the battery module and the battery pack.

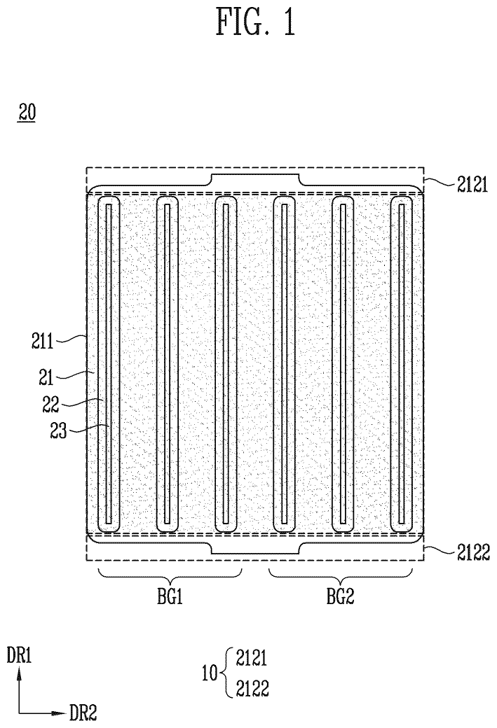

The present disclosure relates to a busbar 20 in one embodiment. The busbar 20 may electrically connect the battery assembly 100 to the inside and outside. FIGS. 1 to 3 are front views of the busbar of one embodiment.

The busbar 20 may include a plate 21 and a plurality of slots 23 formed at the plate 21. In the slots 23, the electrode leads 12 and 13 of the battery cell 10 may be inserted.

In one embodiment, the slot 23 may refer to a hole extending in a specific direction. The plurality of slots 23 may each be extended in a first direction DR1.

In one embodiment, the plurality of slots 23 may be spaced apart from each other in the busbar 20. Here, the plurality of slots 23 may be spaced apart from each other in a second direction DR2. The plurality of slots 23 may be spaced apart from each other in the busbar 20 in the second direction DR2 and at a predetermined distance.

In the present disclosure, the first direction DR1, the second direction DR2, and a third direction DR3 may refer to different relative directions. For example, the first direction DR1 to the third direction DR3 may be perpendicular to each other.

In the present disclosure, that a plurality of elements are identical, perpendicular, or parallel to each other may include not only cases where they are strictly identical, perpendicular, or parallel to each other, but also cases where they are identical, perpendicular, or parallel within a slight margin of error (e.g., ±5%).

In one embodiment, the plate 21 may have a predetermined shape. If the plate 21 has the predetermined shape, current may be supplied uniformly to the busbar 20 regardless of the shape in which the electrode leads 12 and 13 are attached to the busbar 20. As a result, the battery assembly 100 to which the busbar 20 is applied may secure thermal stability.

In one embodiment, the plate 21 may include a body 211 and a protrusion 212 formed by extending at least a part of the body 211. The plurality of slots 23 may be formed at the body 211. The protrusion 212 may be formed by extending at least a part of the body 211 in the direction in which the plurality of slots 23 extend, i.e., in the first direction DR1. As will be described later, the protrusion 212 formed by at least a part of the body 211 extending in the first direction DR1 may be a first protrusion 2121. Further, the protrusion 212 formed by at least a part of the body 211 extending in the direction opposite to the first direction DR1 may be a second protrusion 2122.

In one embodiment, the protrusion 212 may be modified according to certain rules. For example, the length of the first protrusion 2121 in the first direction DR1 may be modified by certain rules. The length in the first direction DR1 of the first protrusion 2121 may decrease as a distance from a center of the plate 21 increases in the second direction DR2. The area of the plate 21 may decrease from the center to one outer edge. By way of this, the current may be uniformly applied to the busbar 20.

In one embodiment, the length of the first protrusion 2121 in the first direction DR1 may decrease in a specific manner as the distance from the center of the plate 21 increases in the second direction DR2.

In one embodiment, the length of the first protrusion 2121 in the first direction DR1 may decrease as the distance from the center of the plate 21 increases in the second direction DR2, forming at least one step portion.

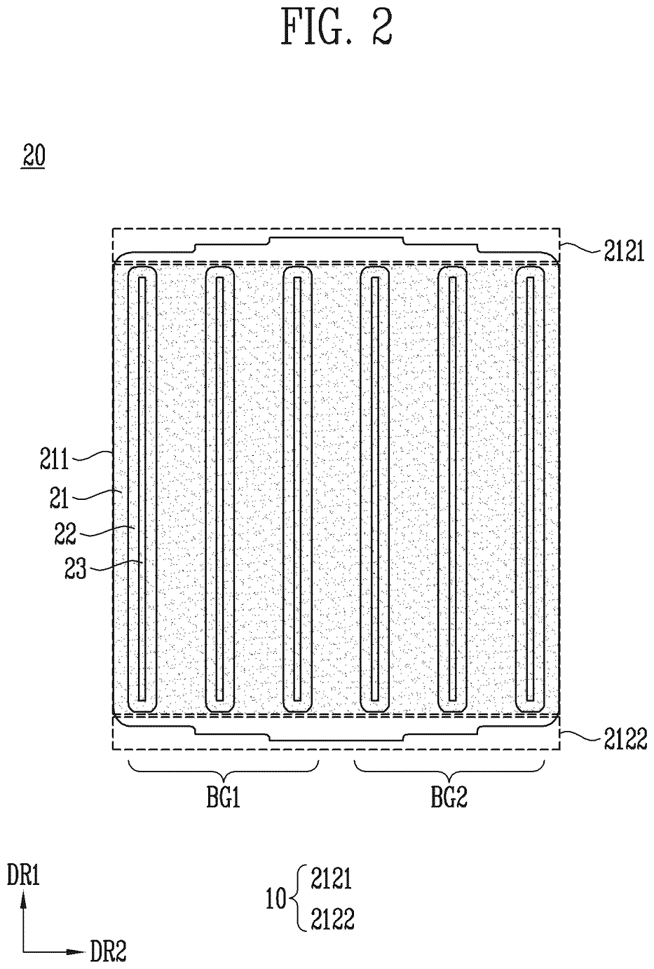

FIGS. 1 and 2 show that the length of the first protrusion 2121 in the first direction DR1 is constant and then decreases at one or more positions while forming steps, as the distance from the center of the plate 21 increases in the second direction DR2.

In one embodiment, the length of the first protrusion 2121 in the first direction DR1 may decrease as the distance from the center of the plate 21 increases in the second direction DR2 forming one step portion. FIG. 1 shows that the length of the first protrusion in the first direction DR1 is constant and then decreases while forming a step at one specific position, as the distance from the center of the plate 21 increases in the second direction DR2.

In one embodiment, the length of the first protrusion 2121 in the first direction DR1 may decrease as the distance from the center of the plate 21 increases in the second direction DR2, forming a plurality of step portions. FIG. 2 shows that the length of the first protrusion 2121 in the first direction DR1 is constant and then decreases while forming steps at a plurality of specific positions, as the distance from the center of the plate 21 increases in the second direction DR2.

In one embodiment, the length of the first protrusion 2121 in the first direction DR1 may decrease as the distance from the center of the plate 21 increases in the second direction DR2, forming at least one step chamfer portion.

FIGS. 1 and 2 show that the length of the first protrusion 2121 in the first direction DR1 is constant and then decreases at one or more positions while forming steps with curved edges, in other words, step chamfer portions, as the distance from the center of the plate 21 increases in the second direction DR2. FIG. 1 shows that the length of the first protrusion 2121 in the first direction DR1 is constant and then decreases while forming a step chamfer portion at one specific position, as the distance from the center of the plate 21 increases in the second direction DR2. FIG. 2 shows that the length of the first protrusion 2121 in the first direction DR1 is constant and then decreases while forming step chamfer portions at a plurality of specific positions, as the distance from the center of the plate 21 increases in the second direction DR2.

In one embodiment, the length of the first protrusion 2121 in the first direction DR1 may decrease as the distance from the center of the plate 21 increases in the second direction DR2 to form an inclined portion.

In the present disclosure, that a length forms an inclined portion in a specific section may mean that the length increases or decreases at a certain slope without forming a step portion within the section.

In other words, in one embodiment, the length of the first protrusion 2121 in the first direction DR1 may decrease with a constant slope without any step portion as the distance from the center of the plate 21 increases in the second direction DR2.

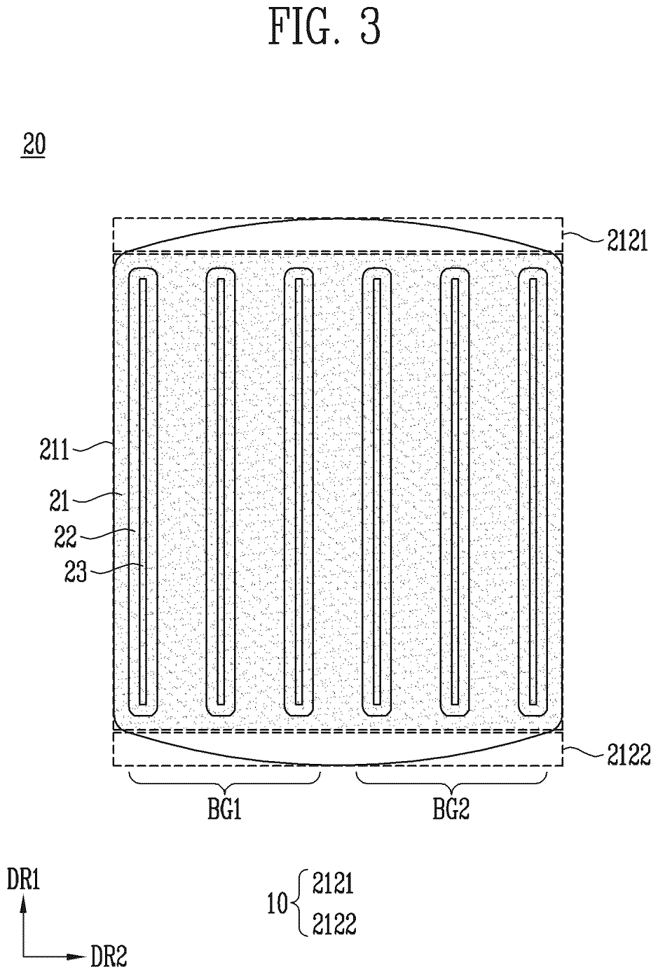

In one embodiment, the length of the first protrusion 2121 in the first direction DR1 may decrease as the distance from the center of the plate 21 increases in the second direction DR2 to form a curved inclined portion. FIG. 3 shows that the length of the first protrusion 2121 in the first direction DR1 decreases as the distance from the center of the plate 21 increases in the second direction DR2 to form a curved inclined portion.

In the present disclosure, that a length forms a curved inclined portion in a specific section may mean that the length does not form a step portion in the section, but increases or decreases with a variable slope.

In one embodiment, the length of the first protrusion 2121 in the first direction DR1 may decrease with a variable slope without a step as the distance from the center of the plate 21 increases in the second direction DR2.

In one embodiment, the change pattern of the length of the first protrusion 2121 in the first direction DR1 along the second direction DR2 in the plate 21 may appear similarly in the direction opposite to the second direction DR2.

In one embodiment, the length of the first protrusion 2121 in the first direction DR1 may decrease while forming one step portion as the distance from the center of the plate increases in the direction opposite to the second direction DR2. FIG. 1 shows that the length of the first protrusion 2121 in the first direction DR1 is constant and then decreases while forming a step at one specific position, as the distance from the center of the plate increases in the direction opposite to the second direction DR2.

In one embodiment, the length of the first protrusion 2121 in the first direction DR1 may decrease while forming a plurality of step portions, as the distance from the center of the plate 21 increases in the direction opposite to the second direction DR2. FIG. 2 shows that the length of the first protrusion 2121 in the first direction DR1 is constant and then decreases while forming steps at a plurality of specific positions, as the distance from the center of the plate 21 increases in the direction opposite to the second direction DR2.

In one embodiment, the length of the first protrusion 2121 in the first direction DR1 may decrease while forming at least one step chamfer portion as the distance from the center of the plate 21 increases in the direction opposite to the second direction DR2.

FIGS. 1 and 2 show that the length of the first protrusion 2121 in the first direction DR1 is constant and then decreases at one or more positions while forming steps with curved edges, in other words, step chamfer portions, as the distance from the center of the plate 21 increases in the direction opposite to the second direction DR2. FIG. 1 shows that the length of the first protrusion 2121 in the first direction DR1 is constant and then decreases while forming a step chamfer portion at one specific position, as the distance from the center of the plate 21 increases in the direction opposite to the second direction DR2. FIG. 2 shows that the length of the first protrusion 2121 in the first direction DR1 is constant and then decreases while forming step chamfer portions at a plurality of specific positions, as the distance from the center of the plate 21 increases in the direction opposite to the second direction DR2.

In one embodiment, the length of the first protrusion 2121 in the first direction DR1 may decrease while forming an inclined portion as the distance from the center of the plate 21 increases in the direction opposite to the second direction DR2. In other words, the length of the first protrusion 2121 in the first direction DR1 may decrease with a constant slope without any step as the distance from the center of the plate 21 increases in the direction opposite to the second direction DR2.

In one embodiment, the length of the first protrusion 2121 in the first direction DR1 may decrease while forming a curved inclined portion, as the distance from the center of the plate 21 increases in the direction opposite to the second direction DR2. In other words, the length of the first protrusion 2121 in the first direction DR1 may decrease with a variable slope without any step as the distance from the center of the plate 21 increases in the direction opposite to the second direction DR2. FIG. 3 shows that the length of the first protrusion 2121 in the first direction DR1 decreases while forming a curved inclined portion as the distance from the center of the plate 21 increases in the direction opposite to the second direction DR2.

The plate 21 may further include the second protrusion 2122, which is another protrusion, on the opposite side of the first protrusion 2121. The shape of the second protrusion 2122 may change in a manner similar to the change in the shape of the first protrusion 2121.

In one embodiment, the plate 21 may further include the second protrusion 2122 formed by extending the body 211 in the direction opposite to the first direction DR1. The length of the second protrusion 2122 in the direction opposite to the first direction DR1 (or a length along the direction opposite to the direction in which the first protrusion 2121 is extended) may decrease as the distance from the center of the plate 21 increases in the second direction DR2.

In one embodiment, the length of the second protrusion 2122 in the direction opposite to the first direction DR1 may decrease while forming at least one step portion as the distance from the center of the plate 21 increases in the second direction DR2.

FIGS. 1 and 2 show that the length of the second protrusion 2122 in the direction opposite to the first direction DR1 is constant and then decreases while forming steps at one or more positions as the distance from the center of the plate 21 increases in the second direction DR2.

In one embodiment, the length of the second protrusion 2122 in the direction opposite to the first direction DR1 may decrease while forming one step portion, as the distance from the center of the plate 21 increases in the second direction DR2. FIG. 1 shows that the length of the second protrusion 2122 in the direction opposite to the first direction DR1 is constant and then decreases while forming a step at one specific position, as the distance from the center of the plate 21 increases in the second direction DR2.

In one embodiment, the length of the second protrusion 2122 in the direction opposite to the first direction DR1 may decrease while forming a plurality of step portions, as the distance from the center of the plate 21 increases in the second direction DR2. FIG. 2 shows that the length of the second protrusion 2122 in the direction opposite to the first direction DR1 is constant and then decreases while forming steps at a plurality of specific positions, as the distance from the center of the plate 21 increases in the second direction DR2.

In one embodiment, the length of the second protrusion 2122 in the direction opposite to the first direction DR1 may decrease while forming at least one step chamfer portion, as the distance from the center of the plate 21 increases in the second direction DR2.

FIGS. 1 and 2 show that the length of the second protrusion 2122 in the direction opposite to the first direction DR1 is constant and then decreases at one or more positions while forming steps with curved edges, in other words, step chamfer portions, as the distance from the center of the plate 21 increases in the second direction DR2. FIG. 1 shows that the length of the second protrusion 2122 in the direction opposite to the length in the first direction DR1 is constant and then decreases while forming a step chamfer portion at one specific position, as the distance from the center of the plate 21 increases in the second direction DR2. FIG. 2 shows that the length of the second protrusion 2122 in the direction opposite to the first direction DR1 is constant and then decreases at a plurality of specific positions while forming step chamfer portions, as the distance from the center of the plate 21 increases in the second direction DR2.

In one embodiment, the length of the second protrusion 2122 in the direction opposite to the first direction DR1 may decrease while forming an inclined portion, as the distance from the center of the plate 21 increases in the second direction DR2. In other words, the length of the second protrusion 2122 in the direction opposite to the first direction DR1 may decrease with a constant slope without any step as the distance from the center of the plate 21 increases in the second direction DR2.

In one embodiment, the length of the second protrusion 2122 in the direction opposite to the first direction DR1 may decrease while forming a curved inclined portion, as the distance from the center of the plate 21 increases in the second direction DR2. In other words, the length of the second protrusion 2122 in the direction opposite to the first direction DR1 may decrease with a variable slope without any step, as the distance from the center of the plate 21 increases in the second direction DR2. FIG. 3 shows that the length of the second protrusion 2122 in the direction opposite to the first direction DR1 decreases while forming a curved inclined portion as the distance from the center of the plate 21 increases in the second direction DR2.

The change pattern of the length of the second protrusion 2122 in the direction opposite to the first direction DR1 along the second direction DR2 in the plate 21 may appear similarly in the direction opposite to the second direction DR2.

In one embodiment, the length of the second protrusion 2122 in the direction opposite to the first direction DR1 may decrease while forming one step portion, as the distance from the center of the plate 21 increases in the direction opposite to the second direction DR2. FIG. 1 shows that the length of the second protrusion 2122 in the direction opposite to the first direction DR1 is constant and then decreases while forming a step at one specific position, as the distance from the center of the plate 21 increases in the direction opposite to the second direction DR2.

In one embodiment, the length of the second protrusion 2122 in the direction opposite to the first direction DR1 may decrease while forming a plurality of step portions, as the distance from the center of the plate 21 increases in the direction opposite to the second direction DR2. FIG. 2 shows that the length of the second protrusion 2122 in the direction opposite to the first direction DR1 is constant and then decreases while forming steps at a plurality of specific positions, as the distance from the center of the plate 21 increases in the direction opposite to the second direction DR2.

In one embodiment, the length of the second protrusion 2122 in the direction opposite to the first direction DR1 may decrease while forming at least one step chamfer portion, as the distance from the center of the plate 21 increases in the direction opposite to the second direction DR2.

FIGS. 1 and 2 show that the length of the second protrusion 2122 in the direction opposite to the first direction DR1 is constant and then decreases at one or more positions while forming steps with curved edges, in other words, step chamfer portions, as the distance from the center of the plate 21 increases in the direction opposite to the second direction DR2. FIG. 1 shows that the length of the second protrusion 2122 in the direction opposite to the first direction DR1 is constant and then decreases while forming a step chamfer portion at one specific position, as the distance from the center of the plate 21 increases in the direction opposite to the second direction DR2. FIG. 2 shows that the length of the second protrusion 2122 in the direction opposite to the first direction DR1 is constant and then decreases at a plurality of specific positions while forming step chamfer portions, as the distance from the center of the plate 21 increases in the direction opposite to the second direction DR2.

In one embodiment, the length of the second protrusion 2122 in the direction opposite to the first direction DR1 may decrease while forming an inclined portion as the distance from the center of the plate 21 increases in the direction opposite to the second direction DR2. In other words, the length of the second protrusion 2122 in the direction opposite to the first direction DR1 may decrease with a constant slope without any step as the distance from the center of the plate 21 increases in the direction opposite in the second direction DR2.

In one embodiment, the length of the second protrusion 2122 in the direction opposite to the first direction DR1 may decrease while forming a curved inclined portion, as the distance from the center of the plate 21 increases in the direction opposite to the second direction DR2. In other words, the length of the second protrusion 2122 in the direction opposite to the first direction DR1 may decrease with a variable slope without any step as the distance from the center of the plate 21 increases in the direction opposite to the second direction DR2. FIG. 3 shows that the length of the second protrusion 2122 in the direction opposite to the first direction DR1 decreases while forming a curved inclined portion, as the distance from the center of the plate 21 increases in the direction opposite to the second direction DR2.

If the plate 21 has the shape as described above, the current may be uniformly supplied to the busbar 20. As a result, the battery assembly 100 including the busbar 20 may secure thermal stability.

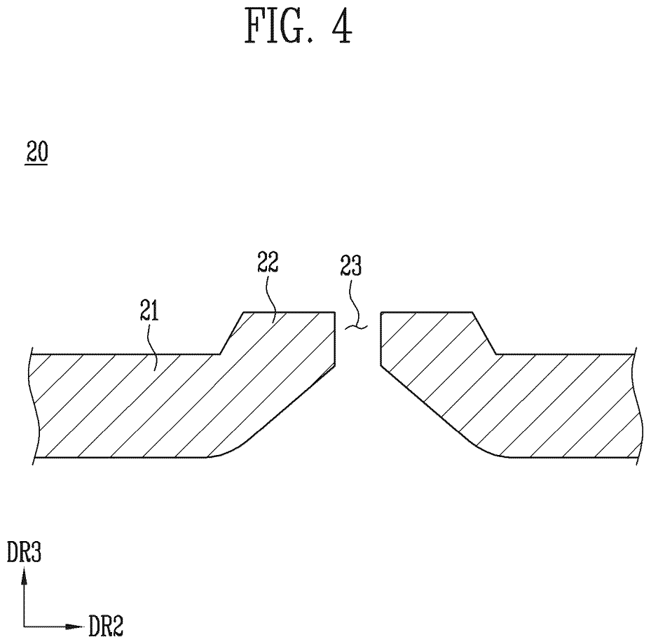

In one embodiment, the shape of the plate 21 around the plurality of slots 23 may also be appropriately modified. FIG. 4 is a plan view of a busbar of one embodiment.

In one embodiment, the electrode leads 12 and 13 may be inserted into the slots in the third direction DR3.

In one embodiment, portions of the plate 21 adjacent to the plurality of slots 23 may be formed to be inclined toward the plurality of slots 23. The portions of the plate 21 adjacent to the plurality of slots 23 into which the electrode leads 12 and 13 are inserted may be formed to be inclined toward the plurality of slots 23. The width of the portion of the plate 21 adjacent to the plurality of slots 23 into which the electrode leads 12 and 13 are inserted may decrease in the third direction DR3. Through this, the electrode leads 12 and 13 may be easily inserted into at least one of the plurality of slots 23.

In one embodiment, the busbar 20 may further include ridges 22 disposed along the circumference of the plurality of slots 23. The ridge 22 may induce the electrode leads 12 and 13 to be inserted into at least one of the plurality of slots 23.

In another embodiment, the present disclosure relates to the battery assembly 100. The battery assembly 100 of one embodiment may include the busbar 20.

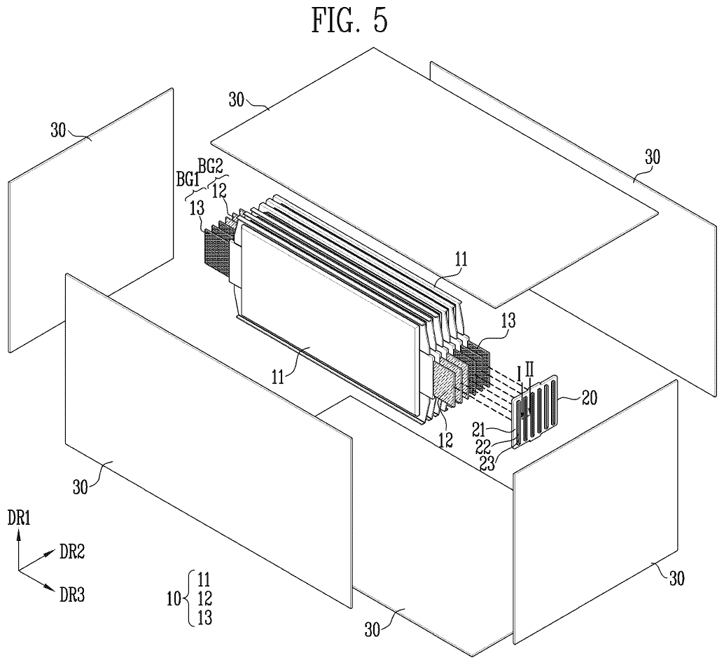

FIG. 5 is an exploded perspective view of the battery assembly 100 of one embodiment.

In one embodiment, the battery assembly 100 may include an accommodating case 30; a first battery cell group BG1; a second battery cell group BG2; and the busbar 20. Here, the busbar 20 may be the busbar as described above. As described above, the busbar 20 comprises a plate 21 disposed on the one side of the first battery cell group BG1 and the second battery cell group BG2; and a plurality of slots 23 formed in the plate, each extending along a first direction DR1, wherein the plurality of slots 23 are spaced apart from each other in a second direction DR2 different from the first direction. The plate comprises a body 212 in which the plurality of slots 23 are formed; and a first protrusion formed by extending at least a part of the body along the first direction DR1, and a length of the first protrusion 2121 in the first direction DR1 decreases as a distance from a center of the plate increases along the second direction DR2.

In one embodiment, the accommodating case 30 may form an accommodating space. Elements constituting the battery assembly 100 may be accommodated in the accommodating space. The battery cell groups BG1 and BG2 may be disposed in the accommodating space. The first battery cell group BG1 and the second battery cell group BG2 may be disposed in the accommodating space. The first battery cell group BG1, the second battery cell group BG2, and the busbar 20 may be disposed in the accommodating space. Whether the battery assembly 100 is a battery module or a battery pack may vary according to the number of battery cells 10 which the accommodating space accommodates and what other elements are connected to the accommodating space.

In one embodiment, the first battery cell group BG1 may be disposed in the accommodating space. The first battery cell group BG1 may include a plurality of first battery cells 10. The first battery cell 10 is the battery cell 10 included in the first battery cell group BG1, and may be used to distinguish it from a second battery cell 10 included in the second battery cell group BG2, which will be described later. The structure, performance, and components of the first battery cell 10 may be the same as the second battery cell 10, which will be described later.

In one embodiment, the plurality of first battery cells 10 may be arranged in parallel in the first battery cell group BG1. Each of the plurality of first battery cells 10 may be arranged so that each of the electrode leads 12 and 13 of the same polarity faces one side in the first battery cell group BG1. In other words, the plurality of first battery cells may be arranged so that each first electrode lead 12 faces one side in the first battery cell group BG1. The plurality of first battery cells 10 may be arranged side by side in the first battery cell group BG1 with each first electrode lead 12 facing one side.

In the present disclosure, the first electrode lead 12 and the second electrode lead included in the battery cell 10 may refer to electrode leads having opposite polarities to each other. For example, when the first electrode lead 12 is a cathode lead, the second electrode lead 13 may be an anode lead, and when the first electrode lead 12 is the anode lead, the second electrode lead 13 may be the cathode lead.

In the present disclosure, the first battery cell group BG1 and the second battery cell group BG2 may each be referred to as a set of battery cells 10 in which the electrode leads 12 and 13 connected to the busbar 20 have opposite polarities.

In one embodiment, the second battery cell group BG2 may be disposed in the accommodating space. The second battery cell group BG2 may include a plurality of second battery cells 10. The second battery cell 10 may be referred to as the battery cell included in the second battery cell group BG2. The structure, performance, and components of the second battery cell 10 may be the same as the first battery cell 10 described above.

In one embodiment, the plurality of second battery cells 10 may be arranged in parallel with each other in the second battery cell group BG2. Each of the plurality of second battery cells 10 may be the same as each other in the second battery cell group BG2, where the electrode leads 12 and 13 with polarity opposite to that of the first battery cell 10 of the first battery cell group BG1 may be disposed to face the one side. In other words, the plurality of second battery cells 10 may be arranged so that each second electrode lead 13 faces the one side in the second battery cell group BG2. The plurality of second battery cells 10 may be arranged side by side in the second battery cell group BG2 with each second electrode lead 13 facing the one side.

In one embodiment, the busbar 20 included in the battery assembly 100 may be the busbar 20 of the above-described embodiment of the present disclosure. Therefore, the busbar 20 may include the plate 21 and the plurality of slots 23 formed on the plate 21. The plate 21 may be disposed on the one side of the first battery cell group BG1 and the second battery cell group BG2. Through this, the busbar 20 may electrically connect the first battery cell group BG1 and the second battery cell group BG2.

In one embodiment, the first electrode lead 12 of the first battery cell group BG1 and the second electrode lead 13 of the second battery cell group BG2 may be inserted into the plurality of slots 23. In addition, the electrode leads 12 and 13 may be attached to the plate 21 so that the busbar 20 may electrically connect the first battery cell group BG1 and the second battery cell group BG2.

In one embodiment, the first electrode lead 12 of the first battery cell group BG1 and the second electrode lead 13 of the second battery cell group BG2 may be attached to the plate 21 while inserted in the plurality of slots 23.

In one embodiment, the electrode leads 12 and 13 may be attached to the plurality of slots 23 by laser welding. However, the electrode leads 12 and 13 may be attached to the plurality of slots 23 using other methods as long as they do not depart from the scope of the present disclosure.

In one embodiment, the first battery cell group BG1 may be placed adjacent to the second battery cell group BG2. In other words, the first electrode lead 12 and the second electrode lead 13 inserted into the busbar 20 may not intersect each other. Referring to FIG. 5, the first electrode lead 12 of the first battery cell group BG1 and the second electrode lead 13 of the second battery cell group BG2 may be inserted into the busbar without intersecting each other.

In one embodiment, the plurality of first battery cells 10 of the first battery cell group BG1 and the plurality of second battery cells 10 of the second battery cell group BG2 may be electrically connected in a specific relationship in the busbar 20. The busbar 20 may electrically connect the plurality of first battery cells 10 of the first battery cell group BG1 to each other in parallel. The busbar 20 may electrically connect the plurality of second battery cells 10 of the second battery cell group BG2 to each other in parallel. The busbar may electrically connect the first battery cell group BG1 and the second battery cell group BG2 to each other in series.

In one embodiment, the number and connection form of the battery cells 10 constituting the first battery cell group BG1 and the second battery cell group BG2 may be determined according to the capacity and output required for a product to which the battery assembly 100 is applied.

In one embodiment, the size of the plurality of slots 23 may be appropriately defined. The size of the plurality of slots 23 may be preferably at least large enough to allow the first electrode lead 12 and the second electrode lead 13 to be inserted. The length of each of the plurality of slots 23 in the first direction DR1 may correspond to the length of each of the first electrode lead 12 and the second electrode lead 13 in the first direction DR1. The length of each of the plurality of slots 23 in the second direction DR2 may correspond to the length of each of the first electrode lead 12 and the second electrode lead 13 in the second direction DR2.

In the present disclosure, that the specification (length, area, volume, etc.) of one element corresponds to the specification of another element means that the specification of the one element is the same as or slightly (e.g., approximately ±1%) larger or smaller than the specification of the other element.

In one embodiment, the advantage of the shape of the busbar 20 described above may be independent of the form in which the electrode leads 12 and 13 of the battery cell groups BG1 and BG2 are inserted and attached to the busbar 20. Hereinafter, the form in which the electrode leads 12 and 13 are inserted and attached to the busbar 20 will be described in detail.

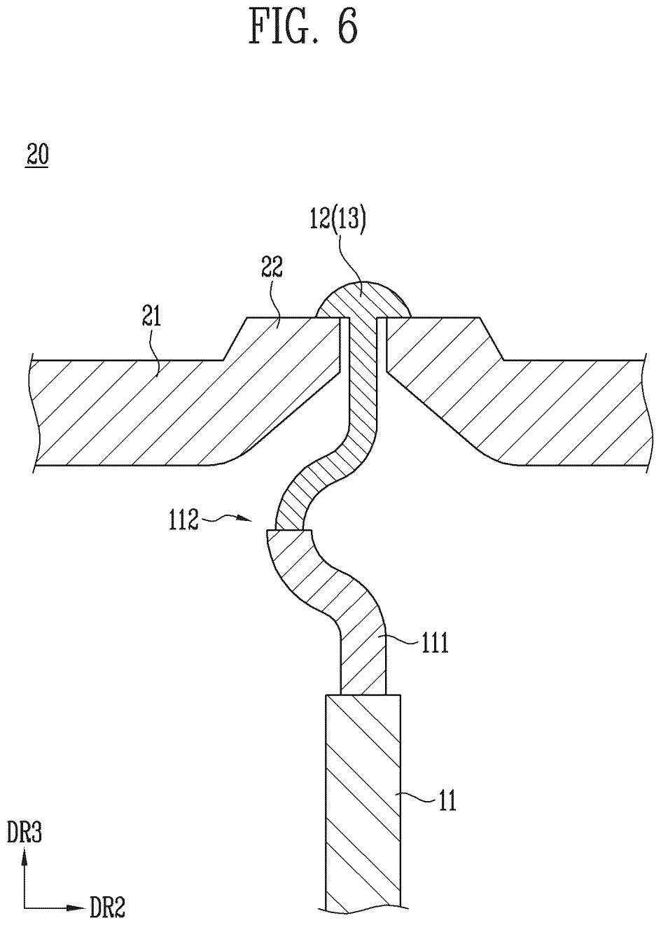

In one embodiment, the shape of the electrode leads 12 and 13 in the busbar 20 may vary according to how the electrode leads 12 and 13 are attached to the busbar 20 through the slots 23. FIGS. 6 to 8 are cross-sectional diagrams taken along line I-II of FIG. 5. FIGS. 6 to 8 may show the electrode lead 12, 13 inserted into the slot 23.

According to FIGS. 6 to 8, the electrode lead 12, 13 inserted into the slot 23 in the third direction DR3 may be fixed to the busbar 20 by being attached to an outer peripheral surface of the slot 23. The plate 21 may be divided into two points based on the slot 23, and the electrode lead 12, 13 may be fixed to the busbar 20 by being attached to at least one of the two points of the plate 21 divided by the slot 23. In one embodiment, at least one of the first electrode lead 12 of the first battery cell group BG1 and the second electrode lead 13 of the second battery cell group BG2 may be attached to an outer peripheral surface of the slot while inserted in the plurality of slots 23.

The electrode lead 12, 13 may protrude from a cell case 11 of the battery cell. Between the protruding electrode lead 12, 13 and the battery cell 10, an insulating portion may be formed to wrap the electrode lead 12, 13. In addition, between the protruding electrode lead 12, 13 and the battery cell 10, a bending portion 112 in which the electrode lead 12, 13 is bent to one side may be formed. The bending portion may have a U-shape. The bending portion 112 may absorb externally applied shocks.

The way the electrode leads 12 and 13 inserted into the slots 23 are attached to the plate 21 may vary according to, for example, conditions of the welding.

In one embodiment, at least one of the first electrode lead 12 of the first battery cell group BG1 and the second electrode lead 13 of the second battery cell group BG2 may be attached to the outer peripheral surface of the slot 23 while inserted in the plurality of slots 23. According to FIG. 6, at least one of the first electrode lead 12 of the first battery cell group BG1 and the second electrode lead 13 of the second battery cell group BG2 may be attached to both of the two points divided by the slot 23 while inserted in the plurality of slots 23. Here, current emitted from the battery cell 10 may be applied uniformly regardless of the shape of the plate 21 of the busbar 20.

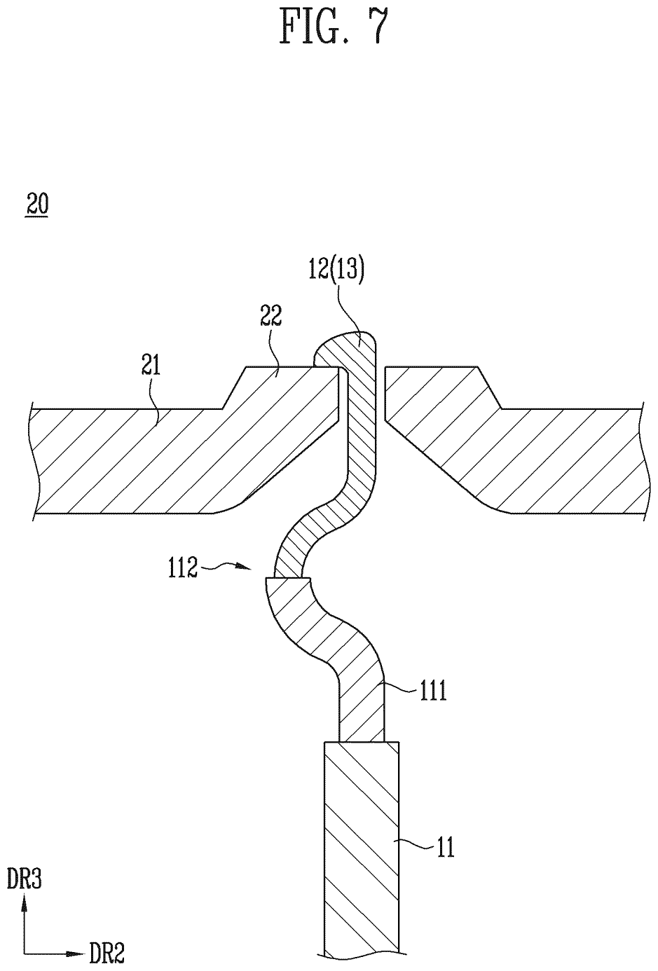

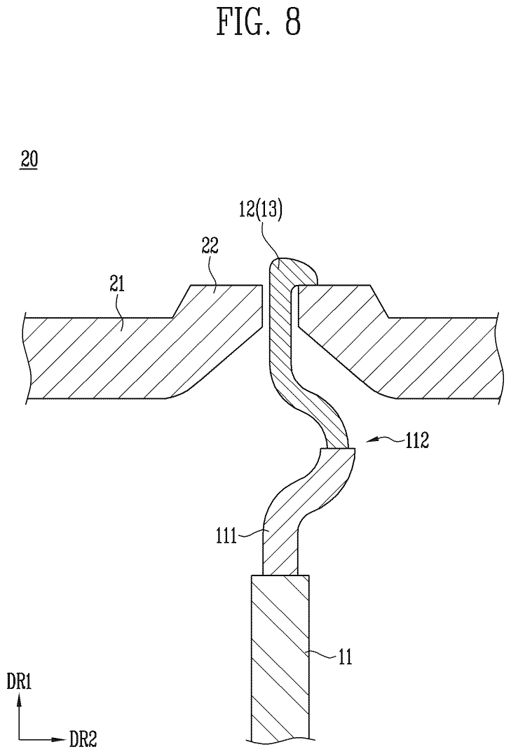

In one embodiment, at least one of the first electrode lead 12 of the first battery cell group BG1 and the second electrode lead 13 of the second battery cell group BG2 may be attached to only one side of the outer peripheral surface of the slot 23 while inserted in the plurality of slots 23. According to FIGS. 7 and 8, at least one of the first electrode lead 12 of the first battery cell group BG1 and the second electrode lead 13 of the second battery cell group BG2 may be attached to only one of the two points divided by the slot 23 while inserted in the plurality of slots 23. Here, the current emitted from the battery cell 10 may be uniformly applied by the shape of the plate 21 of the busbar 20.

The above description is merely examples of applying the principles of the present disclosure, and other configurations may be further included without departing from the scope of the present invention.

What is claimed is:

1. A busbar comprising:
a plate; and
a plurality of slots formed at the plate, each extending along a first direction, and spaced apart from each other along a second direction which is different from the first direction,
wherein the plate comprises:
a body in which the plurality of slots are formed; and
a first protrusion formed by extending at least a part of the body along the first direction, and
wherein a length of the first protrusion in the first direction decreases as a distance from a center of the plate increases along the second direction.

2. The busbar according to claim 1, wherein the length of the first protrusion in the first direction decreases while forming at least one step portion as the distance from the center of the plate increases along the second direction.

3. The busbar according to claim 1, wherein the length of the first protrusion in the first direction decreases while forming one step portion as the distance from the center of the plate increases along the second direction.

4. The busbar according to claim 1, wherein the length of the first protrusion in the first direction decreases while forming a plurality of step portions as the distance from the center of the plate increases along the second direction.

5. The busbar according to claim 1, wherein the length of the first protrusion in the first direction decreases while forming at least one step chamfer portion as the distance from the center of the plate increases along the second direction.

6. The busbar according to claim 1, wherein the length of the first protrusion in the first direction decreases while forming an inclined portion as the distance from the center of the plate increases along the second direction.

7. The busbar according to claim 1, wherein the length of the first protrusion in the first direction decreases while forming a curved inclined portion as the distance from the center of the plate increases along the second direction.

8. The busbar according to claim 1, wherein the plate further comprises a second protrusion formed by extending at least a part of the body along a direction opposite to the direction in which the first protrusion is extended, and
a length of the second protrusion along the direction in which the second protrusion is extended decreases as the distance from the center of the plate increases along the second direction.

9. The busbar according to claim 1, wherein portions of the plate adjacent to the plurality of slots are formed to be inclined toward the plurality of slots.

10. The busbar according to claim 1, further comprising ridges disposed along circumference of the plurality of slots.

11. A battery assembly comprising:
an accommodating case which forms an accommodating space;
a first battery cell group disposed in the accommodating space and comprising a plurality of first battery cells, wherein a first electrode lead of each of the plurality of first battery cells is disposed to face one side;
a second battery cell group disposed in the accommodating space and comprising a plurality of second battery cells, wherein a second electrode lead of each of the plurality of second battery cells is disposed to face the one side; and
a busbar electrically connecting the first battery cell group and the second battery cell group,
wherein the busbar comprises:
a plate disposed on the one side of the first battery cell group and the second battery cell group; and
a plurality of slots formed at the plate, each extending along a first direction, wherein the plurality of slots are spaced apart from each other in a second direction different from the first direction,
the plate comprises:
a body in which the plurality of slots are formed; and
a first protrusion formed by extending at least a part of the body along the first direction, and
a length of the first protrusion in the first direction decreases as a distance from a center of the plate increases along the second direction.

12. The battery assembly according to claim 11, wherein the first electrode lead of the first battery cell group and the second electrode lead of the second battery cell group are attached to the plate while inserted in the plurality of slots.

13. The battery assembly according to claim 12, wherein at least one of the first electrode lead of the first battery cell group and the second electrode lead of the second battery cell group is attached to an outer peripheral surface of the slot while inserted in the plurality of slots.

14. The battery assembly according to claim 12, wherein at least one of the first electrode lead of the first battery cell group and the second electrode lead of the second battery cell group is attached to only one side of an outer peripheral surface of the slot while inserted in the plurality of slots.

15. The battery assembly according to claim 11, wherein the first battery cell group is placed adjacent to the second battery cell group.

16. The battery assembly according to claim 11, wherein the busbar electrically connects the plurality of first battery cells of the first battery cell group to each other in parallel,
electrically connects the plurality of second battery cells of the second battery cell group to each other in parallel, and
electrically connects the first battery cell group and the second battery cell group to each other in series.

17. The battery assembly according to claim 11, wherein a length of each of the plurality of slots in the first direction corresponds to a length of each of the first electrode lead and the second electrode lead in the first direction, and
a length of each of the plurality of slots in the second direction corresponds to a length of each of the first electrode lead and the second electrode lead in the second direction.
